(19) United States
(12) Patent Application Publication
(10) Pub. No.: US 2014/0278542 A1
(43) Pub. Date: Sep. 18, 2014

(54) METHOD AND SYSTEM FOR MEDICAL RECORD COLLECTION AND DISTRIBUTION

(71) Applicant: UNIVAL, Inc., Ann Arbor, MI (US)

(72) Inventor: Ronald E. Fernandez, Ann Arbor, MI (US)

(73) Assignee: UNIVAL, Inc., Ann Arbor, MI (US)

(21) Appl. No.: 14/200,184

(22) Filed: Mar. 7, 2014

Related U.S. Application Data
(60) Provisional application No. 61/781,358, filed on Mar. 14, 2013.

(51) Int. Cl. G06F 19/00

(52) U.S. Cl. CPC G06F 19/322
USPC 705/3

(57) ABSTRACT

A system and method for medical record collection and distribution is provided. The medical records collection and distribution (MRCD) system generally comprises a distributed network of electronic systems in communication with one another; a NAV controller for managing the collection of medical records and viewing the distribution thereof through the patient or provider portals; a dynamic data exchange (DDE), the DDE comprising datasets that include instructions for connecting to the electronic systems and a federated authentication system to validate that the patient or provider is registered with the system and has an active directory record; a domain messaging system adapted to provide a medical record query requesting a patient's medical information; and a means to produce a continuity of care record or documents; the record or documents being provided to the patient or provider portal via the messaging system.

### CROSS REFERENCE TO RELATED APPLICATION

This application claims priority to U.S. Provisional application 61/781,358 filed Mar. 14, 2013, entitled “Method and System for Medical Record Collection and Distribution”, the entire contents of which is herein incorporated by reference.

### FIELD

This disclosure relates generally to the field of data collection and distribution. More specifically, this disclosure relates to a method and system for medical record collection and distribution.

### BACKGROUND

The statements in this section merely provide background information related to the present disclosure and may not constitute prior art.

Many Physicians, specialists and emergency room (ER) staff have to depend on tests run at the time a patient is seen by the ER staff which takes time, outdated medical record information, or on direct communication with a patient's primary care physician. In addition, patients do not usually have their complete medical record information available to them on a timely basis. A method of collecting and distributing such medical records in a quick, but secure fashion, is desirable.

### SUMMARY

The present invention provides a system for collecting and distributing medical records. The medical records collection and distribution (MRCD) system generally comprises a distributed network of electronic systems in communication with one another; a NAV controller for managing the collection of medical records and viewing the distribution thereof through the patient or provider portals; a dynamic data exchange (DDE), the DDE comprising datasets that include instructions for connecting to the electronic systems and a federated authentication system to validate that the patient or provider is registered with the system and has an active directory record; a domain messaging system adapted to provide a medical record query requesting a patient's medical information; and a means to produce a continuity of care record or documents; the record or documents being provided to the patient or provider portal via the messaging system. Optionally, the MRCD system may include a scanned medical records storage that is accessible by the DDE and includes one or more of static and indexed scanned medical records.

In the MRCD system, the distributed network comprises hospital EMR systems, government & private registries, and provider EMRs/practice management that have access to medical records, provider/patient demographic information, and knowledge of the relationships that exist between a provider and a patient. The MRCD system provides for the creation of the medical record query location of all providers that have seen the patient along with establishing a connection with their electronic systems and sending the query to all of these electronic systems in a single process step. The MRCD system then navigates through the medical records and assembles the continuity of care record or documents.

If and when desired, the messaging system in the MRCD system through which queries are received and continuity of care records or documents are provided may be a secure messaging system. If the secure messaging system comprises Security Assertion Markup Language, e.g., SAML token, or another secure single sign-on system, the messaging system can provide a direct means for authentication of the patient or provider.

According to another aspect of the present disclosure, a method of using the aforementioned medical record collection and distribution system is provided. This method generally comprises the steps of registering a requestor with the medical record collection and distribution (MRCD) system as previously described above; requesting access to the MRCD system using a log-in protocol; authenticating the registration of the requestor with the MRCD system; providing a medical record query requesting a patient's medical information; authenticating the authorization of the requestor to view the medical records requested; sending the query to databases having medical records associated with the patient; producing a continuity of care record or documents for the medical records requested; and providing the record or documents back to requestor. The creation of the query, location of all providers that have seen the patient along with establishing a connection with their electronic systems and sending the query to all of these electronic systems is accomplished in a single execution step. Optionally, the query may be received from the requestor and the record or documents are provided back to the requestor using a secure messaging system. The secure messaging system may include SAML token or another secure single sign-on access protocol.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic representation of a medical record collection and distribution system constructed according to the teachings of the present disclosure;

FIGS. 2 is a schematic representation of the sub-systems associated with a provider or patient medical record query;

FIGS. 3 is a schematic representation of the dynamic data exchange module from FIG. 1;

FIG. 4 is a schematic representation of the provider or patient portals of FIG. 1;

FIG. 5 is a schematic representation of the authentication interface for the medical record collection and distribution system;

FIG. 6 is a schematic representation of the registration interface for the medical record collection and distribution system; and

FIG. 7 is a schematic representation of a method of locating, obtaining, analyzing, and reporting desired patient information using the medical record collection and distribution system of FIG. 1.

### DETAILED DESCRIPTION

The following description is merely exemplary in nature and is in no way intended to limit the present disclosure or its application or uses. For example, a data management system made and used according to the teachings contained herein is described throughout the present disclosure in conjunction with medical or health record systems in order to more fully illustrate the system and method of use. The incorporation and use of such a data management system in conjunction with other information storage systems is contemplated to be within the scope of the disclosure. It should be understood that throughout the description and drawings, corresponding reference numerals indicate like or corresponding parts and features.

The present disclosure generally relates to a system and method for locating patient medical information directly from electronic medical record systems, laboratories and optionally scanned patient medical records, upon the receipt of a query from a requestor system. The system allows through either portals, secure messaging, or a web service the ability to collect patient medical information very quickly from all sources available. Many providers are still using paper medical records in their practices, which add to another level of complexity; but, the medical records collection and distribution (MRCD) system of the present disclosure has the capability of indexing scanned medical records, allows queries to be quickly authorized, and provide pages of medical records associated with the information requested in a timely fashion. Upon location of the associated records, a Continuity of Care Record or Continuity of Care Documents is produced that can be then be submitted to the requestor system.

According to one aspect of the present disclosure, the MRCD system may store physician information and connection instructions to make a query to the associated electronic medical record systems, along with instructions to connect to the scanned medical records indexed tables contained therein. In addition, the system may also store patient information and relationships that exist between the patient and physicians.

If a provider or requestor has authorization rights to access a patient's medical information or scanned medical records, a connection record will be returned for each and every provider. The system then initiates according to the connection instructions any queries related to gathering the patient's medical information. If the provider that requested the patient information has used a program with display properties, the system will submit a viewable document. If the user requested the patient information by web service, the encrypted document will be returned via that web service. If the user requested the patient information by secure message, a reply will be generated and the medical record information will become a linked attachment to that secure message. Analytic reporting of both personal information and de-personalized can also be submitted and returned in xml format.

Referring to FIG. 1, the medical record collection and distribution (MRCD) system 1 comprises a distributed network of electronic systems 5, a NAV controller 10; a dynamic data exchange (DDE) module 15, at least one patient 6a or provider 6b portal, and a domain messaging system 21 with said messaging system optionally being a secure messaging system 20, as well as optional access to a scanned index and medical record storage 16. The scanned medical records storage may include one or more of static and indexed scanned medical records. The distributed network of electronic systems 5 may include hospital EMR systems 5a, government and private registries 5b, such as IMM and AHDR, provider EMRs or practice management 5c, and optionally, lab systems 5d. Data can be collected from or transferred to the distributed electronic systems 5 that are integrated with the MRCD system 1. Such data collection and distribution is provided to the distributed electronic system via interaction through the NAV controller 10. The function of the NAV controller 10 is to provide an interface to manage and view hierarchical system content at the provider or patient portals 6a,6b.

The DDE 15 contains datasets that include instructions for connecting to the distributed or remote electronic medical record systems 5a, 5c and registries 5b, and optionally, lab systems 5d that have access to patient information. Also associated with the DDE 15 are datasets that include instructions for connecting to patient portals 6a that have access to a patient's demographic information index and relationships that exist between patients and the systems in which the patient's information is stored. The DDE 15 also contains datasets that include instructions for connecting to physician portals 6b that have access to physician information, as well as information regarding the relationship between the physician and patient. The DDE 15 may optionally be in communication with the storage location of scanned medical records and associated index 16.

Medical information can optionally be made available to the provider or requestor via a domain messaging system 21. Such a domain messaging system 21 can also incorporate a secure messaging system 21 for use in collecting or distributing the information in the context of a secure message. The secure messaging system 20 can be used to obtain query language information that is used by the DDE 15 to authenticate the requestor, parse the patient's information, and process the request. Once the request is completed, the secure messaging system 20 can produce a response and provide the response to the requestor. If the secure messaging system 21 comprises Security Assertion Markup Language, e.g., SAML token, or another secure single sign-on system, the messaging system 21 can provide a direct means for authentication of the patient or provider.

The system 1 has four distinct and different methods for user interaction. The provider can gain access to the system through a web portal which would authenticate the provider by means of a federated authenticated system. A patient can gain access to the system also by way of a web portal which would authenticate the patient by means of the federated authenticated system. A hospital, an emergency room, or a large physician group could use a web service, which would include certificate authentication and accept query information for patients. Finally, a secure message user can also gain access to the system by protocol included in the message. Secure messaging and or SAML token, which is a single sign-on access protocol provides a direct means of authentication.

Referring now To FIG. 2, once the requestor is authenticated, the requestor, which arises from one of the distributed electronic systems 5 (e.g., patient portal 5c, provider portal 5d, etc.) may make a medical record query 50. The medical record query 50 contains patient information, which is then passed to the Patient Index 55 to determine what providers are associated with the patient. This association may include one record, multiple records, or even no records depending upon how many locations and times the patient has been seen by the physician. Once the association between patients and providers has been determined, a provider connection matrix 60 is constructed. The DDE 15 supports the building of the connection matrix 60 by returning a complete dataset of connection points that have medical information available that is relative to the patient. The provider connection matrix 60 is in communication with the provider director 105 (see FIG. 3). An execution dataset 65 that comprises connection data from the providers in the distributed electronic system 5 (e.g., EMR/EHR 5a, registries 5b, etc.) or optionally from the scanned medical records storage 16 is then stored for network availability using a D3connection or similar connection. When queried the medical records are retrieved and assembled into a complete document 70 that reflects the information from all locations that have stored medical information related to the patient. The completed document is then released to the requestor 5 via a secure internal process or an authenticated and secure email or other secure messaging system. The system 1 has the ability to create a query 50, locate of all providers that have seen the patient along with establishing a connection with their electronic systems, and send the query to all of these electronic systems in a single process step.

The query should include at least the patient's first name, last name and date of birth. If two patients having the same first name last name and date of birth are discovered the users will be notified of the presence of multiple records in the system. Additional information than will be needed such as address, telephone number, e-mail address, city, and state or zip code. Insurance information can also be used such as a member ID, if available. Once this criterion is established, a query is generated to discover relationships with all providers', labs and facilities and the scanned medical record if indicated. The connection data set is then created and the connection data set along with the patient information is submitted to all systems in the connection data set. The remote systems will respond to the queries by creating data sets for the patient information and submitting the patient medical information through a secure socket layer back to the system. All returning data sets contain identifiers associated with the initial query so that continuity of care information can be assembled and then submitted to the user.

Referring now to FIG. 3, the Dynamic Data Exchange module 15 comprises several process sub-systems that are made available across the system for functional purposes. These subsystems include provider credentialing 100 that is used to review privileges of the requestor and patient. This sub-system 100 determines the status thereof the requestor's license or authorization to see or obtain the requested medical records. This sub-system 100 is capable of interfacing with an external credentialing mechanism or system. A record of active providers may be retained in a provider directory 105 that is appropriately synced for the requested undertaking. Information regarding the location in which a provider operates can be stored accessibly under practice demographics 110 and is linked via a practice index 115. The practice index 115 provides an interface with patient information and established an index of practices that has a record associated with the patient through a patient-provider index 130.

The practice index 115 also interfaces with a practice connections 135 sub-system within the DDE 15 that comprises the information and definitions related to the various practices that are necessary to identify the relationships between various practices and patients. Similarly, the practice index 115 also can directly interface with EMR Connections 140 and the Medical Records Connection 145 sub-systems that may have unique connectivity protocols or processes. The EMR connections 140 and the Medical Records Connection 145 sub-systems comprise the information and definitions related to various EMRs and between the scanned medical record storage, respectively, that are necessary to determine the patient relationships.

Still referring to FIG. 3, information regarding the location in which the patient lives or seeks medical treatment or coverage can be stored accessibly under patient demographics 120. The patient demographic 120 information is reviewed and compared with all patients in the system 125. A unique system ID is then linked to the patient. The patient provider index 130 provides an interface with provider information and establishes an index of patients that has a record associated with the provider. The practice index 115 and the patient provider index 130 are in sync with one another.

Referring now to FIG. 4, a description of the provider and patient portals 5c, 5d is provided along with the steps necessary for the provider or patient to logon to the system 1. The patient portal 6a and provider portal 6b logs in through the provider or patient login interface 200. The login information provided by the patient or provider is dispatched to the authentication sub-system 300. If the log-in information fails to be authenticated 205, the log-in is denied 215. If the log-in information is successfully authenticated, the provider or patient activity selection interface 220. The provider or patient activity selection interface 220 allows the patient or provider that is logged in to the system 1 multiple options. Several of these options include the ability to modify account information 225, such as telephone, email, address, etc.; the ability to create an information request or query for a medical record 230; provide a secure messaging interface 235; or access and review scanned medical records 240.

Referring now to FIG. 5, the authentication interface 300 starts with the provider or patient attempting to login to the system 1 via the login interface 200. The system 1 generates an authentication request 305. The authentication request 305 is first checked to determine if the provider or patient is registered 310 with the system 1. The authentication request 305 may be in the form of a password. If the patient or provider is not registered, the patient or provider is dispatched to a registration interface 400 in order to complete a registration process. If the provider or patient is registered, the authentication request 305 is then sent as a query to the active directory 320. In order for the authentication to be successful 325, the provider or patient needs to be both registered and have an active directory record. If the authentication is successful 325, a token is created and the patient or provider is returned to the provider or patient activity selection interface 220. If the authentication is not successful an authentication error is sent to the provider or patient portal 205 so that the logon attempt can be denied.

Referring now to FIG. 6, in the registration interface 400 any request to register with the system 1 through a patient 6a or provider 6b portal initializes the registration process 405. The security identification (SID) is checked 410 to ensure accuracy and validity prior to registration being allowed. If the SID is confirmed a flag is set to establish the registration 415 and a message is sent back to the authentication interface 300. If the SID is not confirmed a message is sent to a registration integration module 420, which then aborts the registration process 425 or stores the registration 430 for future confirmation 415.

According to another aspect of the present disclosure, a method of using the aforementioned medical record collection and distribution system is provided. This method 500, as shown in FIG. 7, generally comprises the steps of registering a requestor 505 with the medical record collection and distribution (MRCD) system as previously described above; requesting access to the MRCD system using a log-in protocol 510; authenticating the registration of the requestor with the MRCD system 515; providing a medical record query requesting a patient's medical information 520; authenticating the authorization of the requestor to view the medical records requested 525; sending the query to databases that have medical records associated with the patient 530; producing a continuity of care record or documents for the medical records requested 535; and providing the record or documents back to requestor 540. The creation of the query 520, the location of all providers that have seen the patient along with establishing a connection with their electronic systems, and sending the query to all of these electronic systems is accomplished in a single process step. Optionally, the query may be received from the requestor 520 and the record or documents are provided back to the requestor 540 using a secure messaging system. When the messaging system includes SAML token or another secure single sign-on access protocol 545, the messaging system can provide a direct means for authentication of the patient or provider.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A system for collecting and distributing medical records, the medical records collection and distribution (MRCD) system comprising:
a distributed network of electronic systems in communication with one another; the distributed network comprising hospital EMR systems, private and government registries, provider EMRs and practice management systems, and optionally, lab systems; the electronic systems having access to medical records, provider/patient demographic information, and knowledge of the relationships that exist between a provider and a patient;
at least one provider or patient portal; the provider or patient portal being in communication with the distributed network
a NAV controller for managing the collection of medical records and the distribution thereof through the patient or provider portals;
a dynamic data exchange (DDE); the DDE comprising datasets that include instructions for connecting to the electronic systems and a federated authentication system to validate that the patient or provider is registered with the system and has an active directory record;
a domain messaging system; the messaging system adapted to provide a medical record query requesting a patient's medical information;
optionally, a scanned medical records storage; the scanned storage being accessible by the DDE; and
a means to produce a continuity of care record or documents; the record or documents being provided to the patient or provider portal via the messaging system;
wherein the creation of the medical record query, location of all providers that have seen the patient along with establishing a connection with their electronic systems, and sending the query to all of these electronic systems is accomplished in a single process step.

2. The MRCD system according to claim 1, wherein the messaging system is a secure messaging system.

3. The MRCD system according to claim 2, wherein the messaging system includes SAML token or another secure single sign-on system and provides a direct means for authentication of the patient or provider.

4. The MRCD system according to any of claims 1-3, wherein the scanned medical records storage includes one or more of static and indexed scanned medical records.

5. A method of collecting and distributing medical records; the method comprising the steps of:
registering a requestor with the medical record collection and distribution (MRCD) system defined according to any of claims 1-4;
requesting access to the MRCD system using a log-in protocol authenticating the registration of the requestor with the MRCD system;
providing a medical record query requesting a patient's medical information
authenticating the authorization of the requestor to view the medical records requested
sending the query to databases that have medical records associated with the patient;
producing a continuity of care record or documents for the medical records requested; and
providing the record or documents back to requestor;
wherein the creation of the query, the location of all providers that have seen the patient along with establishing a connection with their electronic systems, and sending the query to all of these electronic systems is accomplished in a single process step.

6. The method according to claim 5, wherein the query is received from the requestor and the record or documents are provided back to the requestor using a secure messaging system.

7. The method according to claim 6, wherein the secure messaging system includes SAML token or another secure single sign-on access protocol and can directly authenticate the patient or provider.
